(19) United States
(12) Patent Application Publication
(10) Pub. No.: US 2004/0195158 A1
(43) Pub. Date: Oct. 7, 2004

(54) Hard-chromed sieve basket

(76) Inventors: Walter Gisin, Horn (CH); Michael Hekli, Horn (CH)

Correspondence Address: BROWDY AND NEIMARK, P.L.L.C., 624 NINTH STREET, NW, SUITE 300, WASHINGTON, DC, 20001-5303, US

(21) Appl. No.: 10/484,037

(22) PCT Filed: Jun. 10, 2002
(86) PCT No.: PCT/CH02/00303

(30) Foreign Application Priority Data
Jul. 17, 2001 (CH) 1316/01

(51) Int. Cl. B01D 35/14

(52) U.S. Cl. 210/94; 210/497.01; 210/500.1

(57) ABSTRACT

A hard-chromed element, in particular a sieve basket, comprises a base body (1) made from a base material, whereby a surface of the base body (1) is provided with a first hard-chrome layer (3). An indicator layer (2), visually different from the first hard-chrome layer (3) is provided between the first hard-chrome layer (3) and the base body (1). An emergency layer (2, 4) is preferably provided, with an increased wear resistance, such that a new chroming of the corroded element can be prepared unhurriedly.

### TECHNICAL FIELD

The invention relates to a hard-chromed element, in particular a sieve basket, in accordance with the preamble of patent claim 1.

### PRIOR ART

To increase the resistance to corrosion and the resistance to wear, elements, for example elements made from steel, are electroplated, in particular industrially hard-chromed. In this case, it is possible to renew the hard chromium plating, i.e. to recoat the element, if some of the hard chromium plating has worn away.

The papermaking industry, in particular waste paper recycling, makes use of screen baskets made from special steel, the surfaces of which are provided with a hard chromium layer in order to increase the resistance to wear. These sieve baskets can also be recoated. However, the sieve baskets comprise a multiplicity of rods which are substantially triangular in cross section and therefore have numerous tips. The abrasion is strongest at these tips, and consequently it is here that the chromium layer is worn away first. However, since the magnetic measurement methods which are customarily used to determine the layer thickness fail at these tips, it is relatively difficult to determine the optimum time for recoating. Premature recoating increases costs and leads to unnecessary interruptions to production. If use of the sieve basket is prolonged excessively, the base material will also be worn away at the tip, so that the sieve basket is irreparably damaged. The latter situation represents serious damage, since these baskets are relatively expensive. Renewing the hard chromium plating would only incur one twentieth of the production costs.

It is known to provide tools with an indicator layer which makes the wear state of the tool visible. For example, DE-A 35 33 534 discloses a dental grinding tool made from steel which has a metallic interlayer and a silvery-white outer layer of nickel. The outer layer of nickel is studied with diamonds or other granular abrasives.

DE-A 199 09 871 likewise shows a wear indicator for a material which is prone to wear. This indicator layer consists of copper, nickel, chromium or precious metals.

### SUMMARY OF THE INVENTION

Therefore, it is an object of the invention to provide a hard-chromed element, in particular a sieve basket, which makes it possible to detect the optimum time for renewing the chromium plating.

This object is achieved by a hard-chromed element having the features of patent claim 1.

According to the invention, an indicator layer which is different optically, in particular in terms of its color, from the hard chromium layer is present between a base material and the hard chromium layer of the element. Consequently, it is possible to detect whether the hard chromium layer has worn away even at geometrically complicated or relatively inaccessible locations, in particular at tips.

In a simple embodiment, the indicator layer is applied direct to the base material.

In a preferred embodiment, there is an emergency running layer with an increase wear resistance; in a first variant, the indicator layer itself forms this emergency running layer. In a second variant, a second hard chromium layer is provided between the indicator layer and the base material. This second hard chromium layer serves as an emergency running layer in order to protect the base material from abrasion until the chromium plating can be renewed. In this case, it is preferable for a stress buffer layer, which compensates for tensile stresses and thereby prevents the indicator layer from cracking or flaking off, to be present between the second hard chromium layer and the indicator layer.

Further advantageous embodiments will emerge from the dependent patent claims.

### BRIEF DESCRIPTION OF THE DRAWING

The text which follows explains the subject matter of the invention on the basis of preferred exemplary embodiments which are illustrated in the appended drawings, in which;

FIG. 1 shows a diagrammatic depiction, not to scale, of a layer structure of a hard-chromed screen basket according to the invention in a first embodiment;

FIG. 2 diagrammatically depicts a second embodiment, and

FIG. 3 diagrammatically depicts a third embodiment.

### WAYS OF CARRYING OUT THE INVENTION

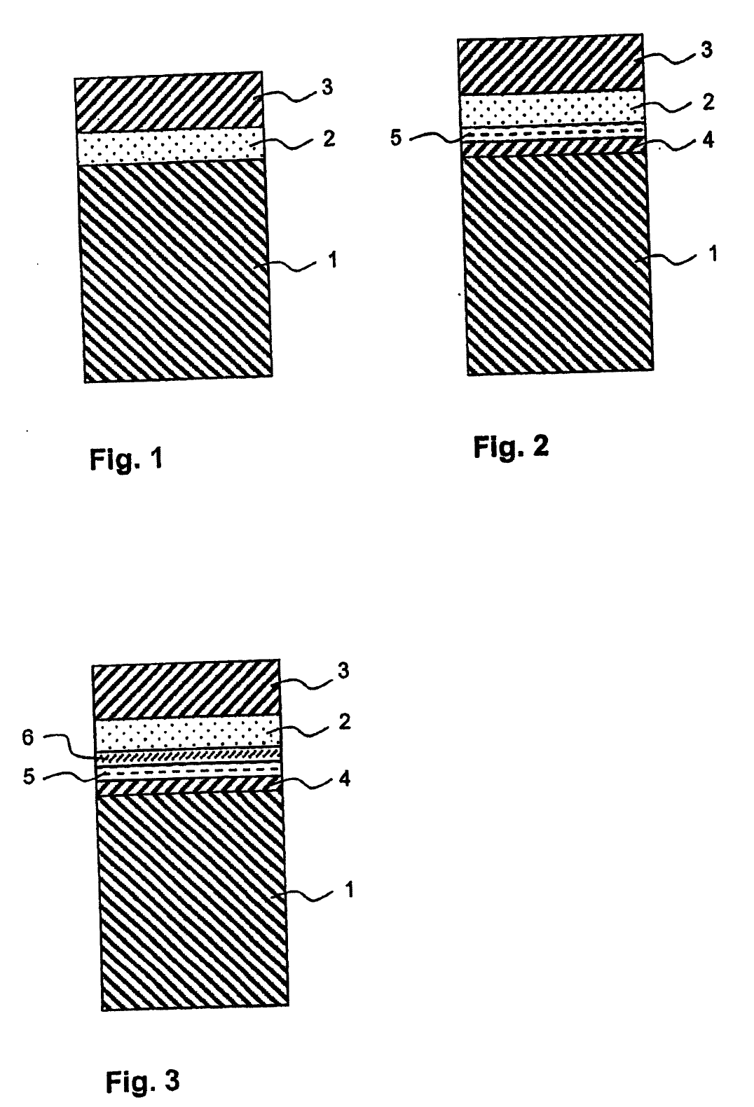

FIG. 1 illustrates a first, simple exemplary embodiment of a layer structure according to the invention of a sieve basket. The sieve basket has a base body 1 made from a base material, preferably from special steel.

An indicator layer 2 is applied to this base body 1.

The material of the indicator layer 2 preferably differs optically, in particular in terms of its color, from the base material 1. On account of its low cost, it is preferable for copper to be used as the indicator layer 2. However, other materials, for example nonferrous metals, such as brass or bronze, gold, metal ceramics, metal oxides, conductive plastics, black chromium or black nickel, are also suitable. Furthermore, the indicator layers may be formed from metal dispersions or electrochemical dispersions layers, such as nickel or copper with colored micro-capsules as dispersed phase, or they may consist of CVD, PVD or thermally sprayed layers.

A hard chromium layer 3 is applied to the indicator layer 2, the indicator layer 2 being selected in such a way that it differs at least optically, and in particular in terms of its color, from the hard chromium layer 3. If the hard chromium layer 3 is then worn away, the indicator layer 2 optically manifests itself at these locations, showing that the sieve basket needs to have its chromium plating renewed. If the indicator layer 2 consists of a CVD or PVD layer, the sieve basket does not have to be exchanged immediately, since these layers have a relatively good resistance to wear and therefore ensure protection against wear, albeit only for a short time, by acting as what is known as an emergency running layer.

Consequently, there is no need to rush to implement maintenance work on the sieve basket.

If the indicator layer 2 consists of another material, it is recommended to use a structure as illustrated in FIG. 2 on the basis of a second, preferred exemplary embodiment. This structure also allows a variant which is less expensive that the use of the relatively costly CVD and PVD layers. The layers shown in FIG. 1 are once again provided with the same reference numerals. In this case, a second hard chromium layer 4, which forms the emergency running layer, is present between the base material 1 and the indicator layer 2. This hard chromium layer 4 preferably has the same composition as the first hard chromium layer 3 but is significantly thinner. Typical values for a sieve basket are 30-450 μm for the first hard chromium layer 3 and 25-30 μm for the second hard chromium layer 4.

Various bonding agents and activation methods can be used to improve the bonding of the indicator layer 2 on the second hard chromium layer 4. For example, as illustrated in FIG. 2, depending on the material of the indicator layer 2 a bonding layer 5 is present between the second hard chromium layer 4 and the indicator layer 2. This is required in particular if the indicator layer 2 used is plastic. The choice of materials for the bonding layer 5 depends on the type of indicator layer 2. By way of example, it is possible for a nickel strike to be used as bonding agent.

FIG. 3 illustrates a third, likewise preferred exemplary embodiment, which is recommended in particular when the indicator layer 2 used is copper. In this case, a stress buffer layer 6 which absorbs shear forces is present between the bonding layer 5 and the indicator layer 2. In the example illustrated here, the bonding layer 5 once against consists of a nickel strike, and the stress buffer layer 6 consists of electroplated nickel. The bonding layer 5 has a typical thickness of 20-60 μm, and the stress buffer layer 6 has a thickness of greater than 20 μm.

The text which follows describes, with reference to the exemplary embodiment shown in FIG. 3, how the individual layers are applied. In accordance with a known first process step, the base body 1 is hard-chromed using an inner anode. This is followed by rinsing and removal of the inner anode. Next, an anode basket for nickel is fitted and the hard chromium layer is activated in a hydrochloric acid solution. This is followed by an optional rinsing step. Then, first of all the nickel strike and then the electroplated nickel layer are applied. The anode basket for nickel is removed and an anode basket for copper is fitted. Then, the sieve basket is plated with copper and the anode basket for copper removed again, in order to allow a lead-coated steel anode, a lead anode or a platinum-coated titanium anode to be fitted for the hard chromium plating. Coating is carried out using an increased current density, in order to compensate for the influence of the copper layer on the electrical properties. Modifications to this production process are possible depending on the choice of materials. In particular, the indicator layer can be applied by means of thermal spraying or pad application.

The sieve basket according to the invention, through the use of an indicator layer, allows abrasion to be detected in good time. If an emergency running layer is also present, there is no need to rush the implementation of maintenance work on the sieve basket.

List of Reference Symbols

1 Base body

2 Indicator layer

3 First hard chromium layer

4 Second hard chromium layer

5 Bonding layer

6 Stress buffer layer

1. A hard-chromed element, in particular a sieve basket, comprising a base body (1) made from a base material, a surface of the base body (1) being provided with a first hard chrome layer (3), characterized in that an indicator layer (2), which is optically different than the first hard chrome layer (3), is present between the first hard chrome layer (3) and the base body (1).

2. The element as claimed in claim 1, characterized in that the indicator layer (2) consists of a nonferrous metal, of a plastic, of black chromium or of black nickel.

3. The element as claimed in claim 2, characterized in that the indicator layer (2) consists of copper.

4. The element as claimed in claim 1, characterized in that a second hard chromium layer (4) is present between indicator layer (2) and base body (1).

5. The element as claimed in claim 1, characterized in that the second hard chrome layer (4) is significantly thinner than the first hard chrome layer (3).

6. The element as claimed in claim 4, characterized in that a bonding layer (5) is present between the second hard chrome layer (4) and the indicator layer (2).

7. The element as claimed in claim 6, characterized in that the bonding layer (5) is a nickel strike.

8. The element as claimed in claim 4, characterized in that a stress buffer layer (6) is present between the indicator layer (2) and the second hard chromium layer (4).

9. The element as claimed in claim 8, characterized in that the stress buffer layer (6) consists of an electroplated nickel dispersion layer.

10. The element as claimed in claim 1, characterized in that the base body (1) consists of special steel.
